(19) United States
(12) Patent Application Publication
(10) Pub. No.: US 2024/0005331 A1
(43) Pub. Date: Jan. 4, 2024

(54) Multi-Party Payment Distribution Automation

(71) Applicant: Fidelity Information Services, LLC, Jacksonville, FL (US)

(72) Inventors: SUSHEEL NESARGI, Saint Johns, FL (US); George S. Durant, Saline, MI (US); Joel Dake, Hubertus, WI (US); Glen M. Casey, Quinton, AL (US); Prashant Gupta, Brookfield, WI (US); Cary Jeffers, West Bend, WI (US); Karsten Propper, Birmingham, AL (US)

(21) Appl. No.: 18/061,545

(22) Filed: Dec. 5, 2022

Related U.S. Application Data
(60) Provisional application No. 63/367,355, filed on Jun. 30, 2022.

(51) Int. Cl. G06Q 20/40; G06Q 20/02

(52) U.S. Cl. CPC G06Q 20/405; G06Q 20/023

(57) ABSTRACT

Disclosed embodiments relate to systems and methods for automatic payment distribution. Techniques include validating, based on user-specified rules that the received file form data fields match user requirements, determining whether to authenticate a form based on the validation, calculating payment eligibility and payment amount, authorizing recipient payments, and notifying the recipient.

### RELATED APPLICATIONS

This application claims priority to, and incorporates by reference, U.S. Provisional Patent Application No. 63/367,355, filed Jun. 30, 2022.

### TECHNICAL FIELD

The present disclosure generally relates to processing financial payments, and to a system and method for uploading recipient information to determine payment disbursements. In particular, embodiments of the present disclosure relate to inventive and unconventional systems for managing data in multiple formats and streamlining the data to ensure proper payment distribution to recipients based on payment authorization.

### BACKGROUND

There is a need for a platform with a portal that enables businesses and agencies to disburse financial payments to recipients using a streamlined process. The platform accounts for each entities' specific needs, including coordination lists of recipients, recipient financial parameters, and financial amount details. The platform streamlines payments to individuals working for employing entities and are entitled to payment relief. In some embodiments, payments may be made to an entity or sub-entity rather than an individual. In some embodiments, payments may be made to an individual that does not work for an employing entity. In some embodiments, the platform includes customer support in the form of call center agents, to ensure fast and secure payment distribution.

Previous solutions only accounted for customized solutions and are not customizable to each entities' specific needs, enabling reuse of the payment distribution system. Previous solutions did not allow for collaboration or coordination across multiple entities. Existing solutions do not have the ability to incorporate information from multiple businesses or agencies because of issues with requirements for specific data fields and specific data formats. Some existing solutions are catered to specific programs for individual jurisdictions and do not have the capability to incorporate information that is not specific to that particular jurisdiction. Other existing solutions use simple spreadsheets or databases, which cannot be shared for coordination across multiple agencies.

This lack of shared information leads to an inability to determine whether an individual has been paid and could lead to potentially fraudulent activity. Thus, there is a need for a platform that accounts for these deficiencies and allows for agencies to customize specific solutions that are suitable for coordinating among multiple entities. Disbursing funds to recipients requires consolidating details of users, ensuring accurate data information, validating data information, and streamlining payments to recipients.

There is an increasing need for a streamlined system that allows for each entity to customize its specific needs and for consolidation across a single platform. This need may include integration needs across varied payment disbursement systems, where each system has its own set of rules, and cannot easily integrate with other systems.

The present payment distribution system allows for integration of different disbursement systems. The present payment distribution system allows for different entities to upload payment recipient details based on their organization's needs and validates the details based on the organization's specific requirements. The system allows for streamlined payments and payment validation. The system also allows multiple entities to coordinate across the system based on different access rules. Administrators may view reports to validate recipient information and check the status of payments. Customer support agents may also view reports to answer questions.

### SUMMARY

The disclosed embodiments describe an automatic distribution system comprising a database, a memory storing instructions, and at least one processor. In an embodiment, the at least one processor is configured to execute instructions to receive, from a user device, a request to authenticate a recipient file template. The recipient file template may contain data fields for a recipient. The operations further comprise instructions to validate, based on user-specified rules, that the data fields match user requirements; determine whether to authenticate the recipient file template based on the validation; calculate based on the data fields, at least one of payment eligibility and payment amount; authorize an automatic payment to a recipient; and send the payment to a payment disbursement system.

According to disclosed embodiments, the operations may further comprise logging each authorized payment to a recipient as a transaction.

According to disclosed embodiments, the payment to a recipient may further comprise a payment method of at least one of a check, Automated Clearing House (ACH) payment, or debit to a bank account.

According to disclosed embodiments, the operations may further comprise logging each payment method in a positive pay file and generating a notification if a payment is attempted more than once.

According to disclosed embodiments, the recipient may be selected from a database of eligible recipients.

According to disclosed embodiments, the operations may further comprise denying authorization of payment to a recipient and logging the denied authorization of payment to a recipient.

According to disclosed embodiments, the user-specified rules may be configuration based.

According to disclosed embodiments, the operations may further comprise sending a notification of at least one of an email, text message, phone call, or system alert, based on the user-specified rules when a payment is sent to a payment disbursement system.

According to disclosed embodiments, each payment may be an encrypted transaction.

According to disclosed embodiments, there may be a non-transitory computer readable media for automatic payment distribution. For example, in an embodiment, a non-transitory computer readable medium may include instructions that, when executed by at least one processor, cause the at least one processor to perform operations for automatic payment distributions. The operations may comprise instructions to receive, from a user device, a request to authenticate a recipient file template. The recipient file template may contain data fields for a recipient. The operations further comprise instructions to validate, based on user-specified rules, that the data fields match user requirements; determine whether to authenticate the recipient file template based on the validation; calculate based on the data fields, at least one of payment eligibility and payment amount; authorize an automatic payment to a recipient; and send the payment to a payment disbursement system.

According to disclosed embodiments, the operations may further comprise determining a user's authorization or status, wherein the user includes at least one of a read-only user, an upload-only user, a call center agent, or an administrator.

According to disclosed embodiments, the administrator may have full permissions within the user-specified rules including changing the payment recipient's address, re-issuing check payments, or flagging payments for review.

According to disclosed embodiments, the operations may further comprise the call center agent performing at least one of searching for a payment recipient; reporting a payment recipient; searching a database; reviewing payment history; or viewing payment status.

According to disclosed embodiments, the data fields may include personal identifiable information.

According to disclosed embodiments, authorizing a payment may further comprise validating the payment recipient's address and confirming financial information with a financial institution.

According to disclosed embodiments, the operations may further comprise the payment recipient receiving multiple payments.

According to disclosed embodiments, the payment amount may have a limit based on user-specified rules.

According to disclosed embodiments, there may be a computer-implemented method for automatic payment distribution. The method may comprise receiving, from a user device, a request to authenticate a recipient file template. The recipient file template may contain data fields for a recipient. The operations further validating, based on user-specified rules, that the data fields match user requirements; determining whether to authenticate the recipient file template based on the validation; calculating based on the data fields, at least one of payment eligibility and payment amount; authorizing an automatic payment to a recipient; and sending the payment to a payment disbursement system.

According to disclosed embodiments, the user-specified rules may be determined by an employing entity.

According to disclosed embodiments, the operations may further comprise an administrator changing the user requirements.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1A is a flow diagram of payment distribution system 100 focusing on employing entities 106.

FIG. 1B is a flow diagram of payment distribution system 100 focusing on agency administrators 108.

FIG. 1C is a flow diagram of payment distribution 100 focusing on call center agents 110.

FIG. 2 is a block diagram showing an example server, consistent with disclosed embodiments.

FIG. 3 is a flowchart showing an example process for automatic payment distribution, consistent with disclosed embodiments.

FIG. 4 illustrates a search screen, consistent with disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently.

The techniques for automatic payment distribution described herein overcome several technological problems relating to customization, reuse, collaboration, and validation of payments. As discussed above, many current solutions do not allow for an entity to incorporate its specific needs and do not allow for collaboration across multiple entities. Accordingly, disbursing of funds requires multiple checkpoints and systems and does not allow for a streamlined process. Previous solutions relied on spreadsheets or databases that did not allow for coordination across multiple entities. Therefore, there is a need for an improved solution that addresses these problems.

The disclosed embodiments provide technical solutions to overcome these and other problems with the current techniques. In particular, the disclosed techniques allow for disbursing of funds to recipients by consolidating details of users, ensuring accurate data information, validating data information, and streamlining payments to recipients. The present solution ensures that payment recipients are paid on time and in an accurate manner. The present solution also ensures that payment status and payment details for each individual payment recipient are available for administrator and call center agents to view, to ensure updates are communicated to payment recipients. In addition, with thousands of users, it is important that information is accurate. The present solution authorizes payment recipient information and payment disbursement information based on details that are uploaded for each recipient. The present solution also ensures that potentially fraudulent activity is monitored and that payments are not duplicated or sent to an invalid payment recipient. The present solution further ensures that data is processed for each individual once, rather than having overlapping data from multiple entities. This streamlines the process by ensuring data accuracy and provides less stress on the system when searching the database of payment recipients. For these and other reasons, the disclosed embodiments present an improvement over the prior art.

Reference will now be made in detail to the disclosed embodiments, examples of which are illustrated in the accompanying drawings.

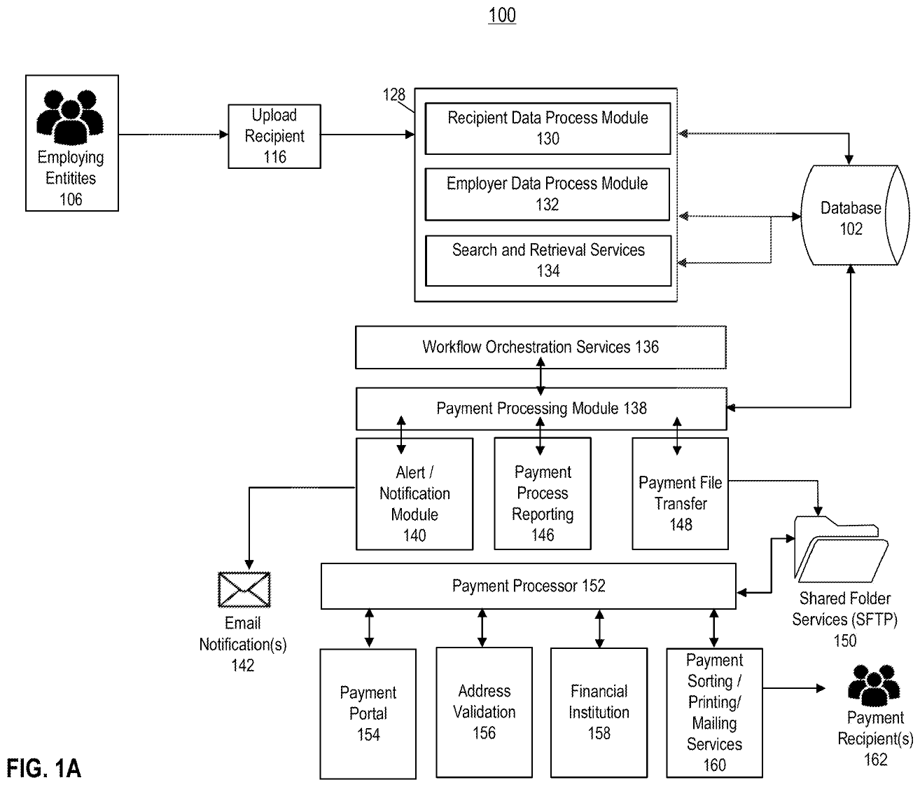

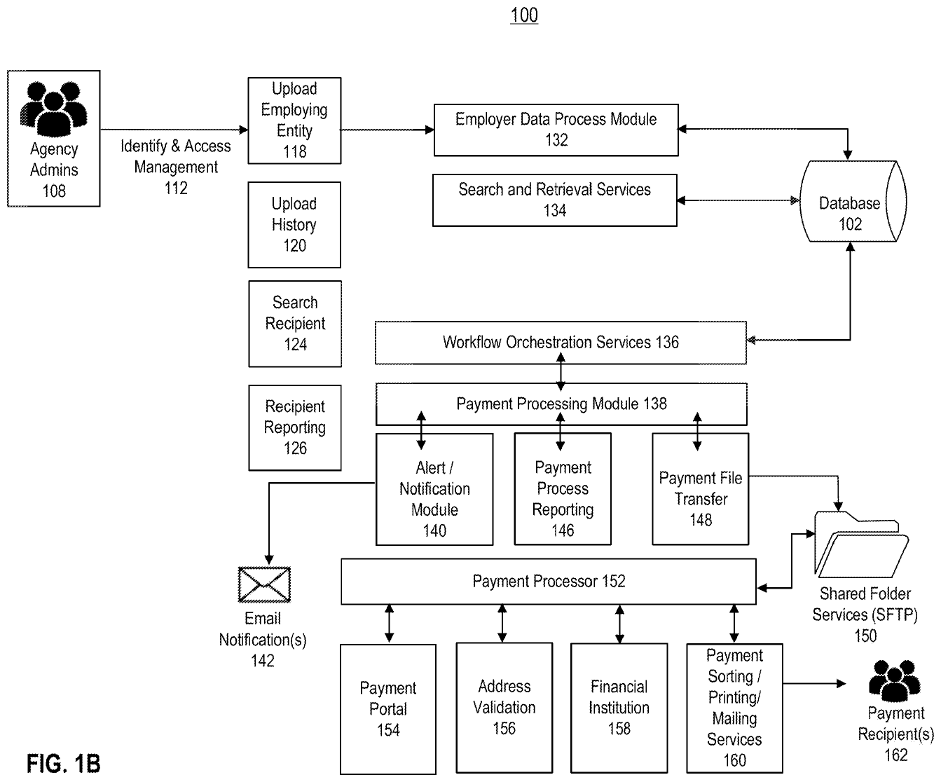

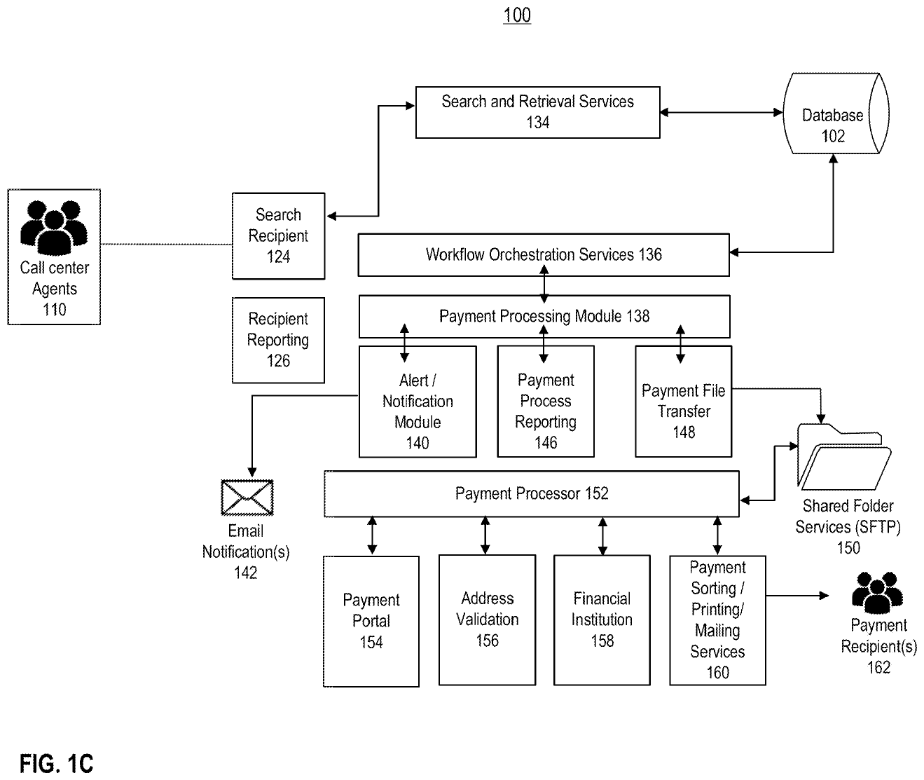

FIG. 1A illustrates an example system environment 100 for automatic payment distribution via the employing entities 106 to payment recipients 162. System environment 100 may include database 102, upload recipient 116, process module 128, recipient data process module 130, employer data process module 132, search and retrieval services 134, workflow orchestration services 136, payment processing module 138, alert and notification module 140, email notification 142, payment processing reporting 146, payment file transfer 148, shared folder services 150, payment process 152, payment portal 154, address validation 156, financial institution 158, and payment sorting, printing and mailing services 160. For purposes of discussion, in some embodiments, the entities in the payment processing system communicate electronically with each other through known means of electronic communication, such as wired or wireless networks. In some embodiments, system 100 is an Internet web application. In some embodiments, system 100 integrates with other systems to issue payments using batch payment files. In some embodiments, system 100 is hosted on FIS software, with connectivity to the cloud. In some embodiments, the cloud environment consists of servers that are accessed over the Internet and software and databases run on those servers.

The various components of system 100 may be stored in database 102. Database 102 may be included on a volatile or non-volatile, magnetic, semiconductor, tape, optical, removable, non-removable, or other type of storage device or tangible or non-transitory computer-readable medium. Database 102 may include one or more memory devices that store data and instructions used to perform one or more features of the disclosed embodiments. Database 102 may include any suitable databases, ranging from small databases hosted on a work station to large databases distributed among data centers. Database 102 may also include any combination of one or more databases controlled by memory controller devices or software. For example, database 102 may include document management systems, Microsoft SQL™ databases, SharePoint™ databases, Oracle™ databases, Sybase™ databases, other relational databases, or non-relational databases, such as Mongo and others.

Employing entities 106 may include an agency or department. Employing entities 106 may be a legal entity responsible for payroll based taxes with respect to an employee. In some embodiments, employing entities have a predetermined level of authorization. In some embodiments, employing entities 106 upload the upload recipient 116 to database 102 over a network. In some embodiments, before employing entities 106 can upload the upload recipient 116 to database 102, they may have to log in to system 100 to verify credential information before proceeding to upload information at upload recipient 116. In some embodiments, credential information includes verifying information stored in database 102 matches information entered by employing entities 116 at log in. Upload recipient 116 may consist of one or more recipients eligible for automatic payment distributions from employing entities 106. At upload recipient 116, employing entities 106 upload relevant payment recipient 162 information. In some embodiments, at upload recipient 116, employing entities 106 uploads a recipient file template, which contains various formats and fields based on rules specified by employing entities 106. In some embodiments, the recipient file template may be of file formats such as Excel, flat file, database, CSV, YAML, and XML. Upload recipient 116 allows for thousands of file templates to be uploaded simultaneously.

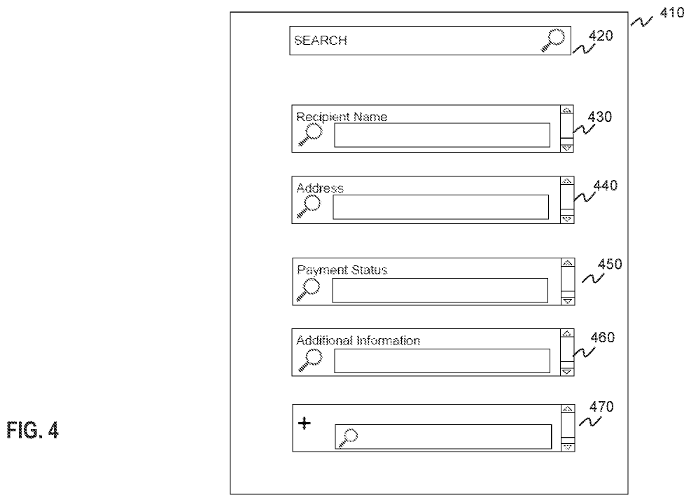

At process module 128, one or more operations including recipient data process module 130, employer data process module 132, and search and retrieval services 134 may occur. These operations may occur simultaneously. Recipient data process module 130 processes the upload recipient 116 information. In some embodiments, recipient data process module 130 parses the contents of the upload recipient 116 information and validates the contents of the upload recipient 116 information against user-specified rules. In some embodiments, if the contents are validated, the information in upload recipient 116 information is stored in a database. In other embodiments, if the contents are not validated, a validation error is presented to employing entities 106. In some embodiments, process module 128 processes the recipient file template based on various identifying fields, including demographic details and employment information. In some embodiments, system 100 securely logs each time a recipient file template is uploaded. In some embodiments, database 102 maintains records for all upload attempts and the outcome of all upload attempts. In some embodiments, the outcome may be a successful payment. In other embodiments, the outcome may be a validation error, leading to an unsuccessful payment attempt. Employer data process module 132 process information received from employing entities 106. At search and retrieval services 134, system 100 communicates with database 102 over a network to search for information regarding upload recipient 116. FIG. 4 illustrates an example of a search screen where users can search for different upload recipients. A search for information may be configured by employing entities 106. A search for information may be based on payment status. At workflow orchestration services 136, system 100 handles the automation of data movement throughout system 100. In some embodiments, workflow orchestration services 136 schedules jobs to create and send payments.

At payment processing module 138, system 100 begins processing a payment for automatic distribution. The sub-modules of payment processing module 138 include alert and notification module 140, payment processing reporting 146, and payment file transfer 148. At alert and notification module 140, an email notification 142 may be sent to employing entities 106. In some embodiments, payment processing module 138 sends an email notification 142 over a network to employing entities 106. In some embodiments, employing entities 106 may choose whether to receive email notifications. Email notifications may be helpful to employing entities 106 to keep electronic records of authorized payments. At alert and notification module 140, an alert may be sent to payment recipient 162 informing payment recipient 162 of the status of the payment. At payment processing reporting 146, a notification may be sent to employing entities 106. At payment file transfer 148, the payment is sent to shared folder services 150 for further processing. Shared folder services 150 operations through secure file transfer protocol and runs over the SSH protocol. At shared folder services 150, the file transfer is secured through a network protocol that provides file access, file transfer, and file management.

At payment processor 152, system 100 loads information into payment portal 154. At payment processor 152, system 100 confirms validation of the payment. In some embodiments, if a validation issue occurs, the payment recipient 162 may see the specific validation issue. Payment portal 154 may be a merchant service that authorizes direct payments for processing. Payment portal 154 allows employing entities 106 to send invoices to payment recipients 162 through system 100. At payment portal 154, using payment processor 152, a payment method is determined based on the user-specified rules. In some embodiments, the user-specified rules allow for different payment methods. In other embodiments, the user-specified rules only allow for one type of payment method. A payment method may be at least one of a check, ACH payment, or debit to a bank account.

At payment processor 152, system 100 perform an address validation at address validation 156. At address validation 156, system 100 confirms that the address provided by employing entities 106 meets address standards. In some embodiments, address standards include verifying that the address has a street, zip code, city, and state or jurisdiction. An address may include the number of a residence, name of a road, and name of a town where payment recipient 162 resides.

At financial institution 158, payment processor 152 confirms payment recipient 162 financial institution information. A financial institution is a business entity that provides services for different types of financial monetary transactions. At financial institution 158, payment processor 152 may verify financial institution information by auditing the provided financial institution information for accuracy. Verification may include confirming bank account information and routing information. Verification may also include checks on account numbers and routing numbers to ensure that the numbers are the correct format and length.

At payment sorting, printing, and mailing services 160, payment processor 152 sorts payments. In some embodiments, payment printing may occur. In some embodiments, payment processor 152 may mail confirmation of a payment through payment sorting, printing, and mailing services 160. In some embodiments, payment recipient 162 may receive multiple payments.

FIG. 1B illustrates an example system environment 100 for automatic payment distribution via the agency administrators 108. FIG. 1B depicts employer data process module 132, search and retrieval services 134, workflow orchestration services 136, payment processing module 138, alert and notification module 140, email notification 142, payment processing reporting 146, payment file transfer 148, shared folder services 150, payment process 152, payment portal 154, address validation 156, financial institution 158, and payment sorting, printing and mailing services 160, and payment recipients 162, described above with respect to FIG. 1A. FIG. 1B also depicts identify and access management 112, upload employing entity 118, upload history 120, search recipient 124, and recipient reporting 126. Agency administrators 108 may have full permissions within system 100 to make changes within system 100. At identify and access management 112, system 100 confirms an agency administrator 108 status. In some embodiments, confirming an agency administrator status requires an agency administrator 108 to log in using credential verification.

At upload employing entity 118, agency administrators 108 upload relevant employing entity information. In some embodiments, agency administrators 108 manually upload the employing entity information. In other embodiments, agency administrators 108 upload received files from employing entities 106.

At upload history 120, agency administrators 108 may view all upload history for an employing entity 118. In some embodiments, upload history 120 includes who uploaded data, when data was uploaded, whether the data was imported or rejected, the employing entity 106, and the upload status. In some embodiments, the data is uploaded with a time stamp.

At search recipient 124, agency administrators 108 may search for any payment recipients 162. Search parameters may include a payment recipient 162 by name, address, or other personal identifiable data. In some embodiments, search recipient 124 searches database 102 to pull search results.

At recipient reporting 126, agency administrators 108 may report to a payment recipient 162 that a payment is made. In some embodiments, agency administrators 108 have a predetermined level of authorization. Agency administrators 108 may be authorized to report via telephone call or email. Agency administrators 108 may be authorized to flag payments for review. Agency administrators 108 may be authorized to initiate address changes. Agency administrators 108 may be authorized to re-issue check payments.

FIG. 1C depicts employer data process module 132, search and retrieval services 134, workflow orchestration services 136, payment processing module 138, alert and notification module 140, email notification 142, payment processing reporting 146, payment file transfer 148, shared folder services 150, payment process 152, payment portal 154, address validation 156, financial institution 158, and payment sorting, printing and mailing services 160, and payment recipients 162, described above with respect to FIG. 1A. FIG. 1C also depicts an example system environment 100 for automatic payment distribution via the call center agents 110. In some embodiments, a call center agent is a customer service professional that handles phone calls, emails, live chat messages, and support tickets related to system 100. In some embodiments, call center agents 110 have a predetermined level of authorization. Levels of authorization may be determined by rules specified by employing entities. In some embodiments, call center agents must log in using credential verification to access system 100. Call center agents 110 have different permissions than agency administrators 108. Call center agents 110 may search for a payment recipient at search recipient 124. A search may be conducted based on a payment recipient's name, address, phone number, or other personal identifiable information associated with the payment recipient. In some embodiments, call center agents 110 will verify a caller before providing information to a caller. Call center agents 110 may report a payment recipient at recipient reporting 126. Call center agents 110 may review recipient payment history. In some embodiments, reviewing the payment recipient history requires performing a search and then viewing whether one or more payments were made. The recipient payment history may include the date a recipient was paid, the amount a recipient was paid, and the form of payment (ACH payment, check, or debit). Call center agents 110 may view a recipient payment status. In some embodiments, call center agents 110 may not have permissions to make changes within system 100.

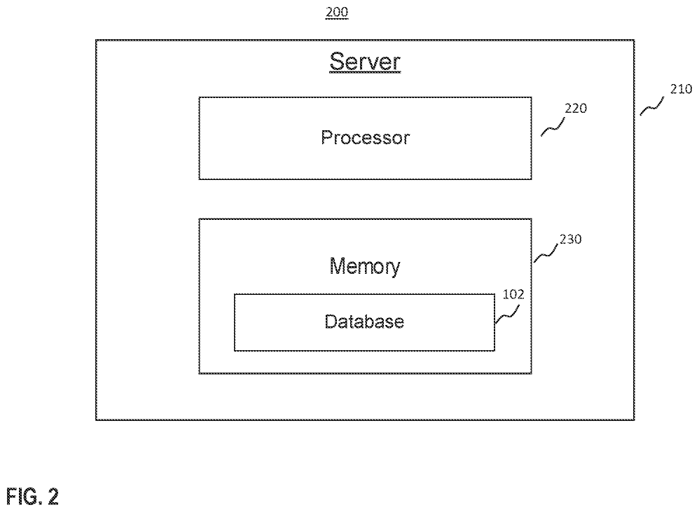

FIG. 2 is a block diagram showing an example server 210, consistent with the disclosed embodiments. Server 210 may be a computing device (e.g., a server, etc.) and may include one or more dedicated processors and/or memories. For example, server 210 may include a processor (or multiple processors) 220, a memory (or multiple memories) 230, and a database 102, as shown in FIG. 2.

Database 102 may also be part of server 210 or may be separate from server 210. When database 102 is not part of server 200, server 210 may exchange data with database 102 via a communication link.

Processor 220 may take the form of, but is not limited to, a microprocessor, embedded processor, or the like, or may be integrated in a system on a chip (SoC). Furthermore, according to some embodiments, processor 220 may be from the family of processors manufactured by Intel®, AMD®, Qualcomm®, Apple®, NVIDIA®, or the like. The processor 220 may also be based on the ARM architecture, a mobile processor, or a graphics processing unit, etc. The disclosed embodiments are not limited to any type of processor configured in server 210.

Memory 230 may include one or more storage devices configured to store instructions used by the processor 220 to perform functions related to server 210. The disclosed embodiments are not limited to particular software programs or devices configured to perform dedicated tasks. For example, the memory 230 may store a single program, such as a user-level application, that performs the functions associated with the disclosed embodiments, or may comprise multiple software programs. Additionally, the processor 220 may, in some embodiments, execute one or more programs (or portions thereof) remotely located from server 210. Furthermore, memory 230 may include one or more storage devices configured to store data for use by the programs. Memory 230 may include, but is not limited to a hard drive, a solid state drive, a CD-ROM drive, a peripheral storage device (e.g., an external hard drive, a USB drive, etc.), a network drive, a cloud storage device, or any other storage device.

In some embodiments, memory 230 may include a database 102 as described above.

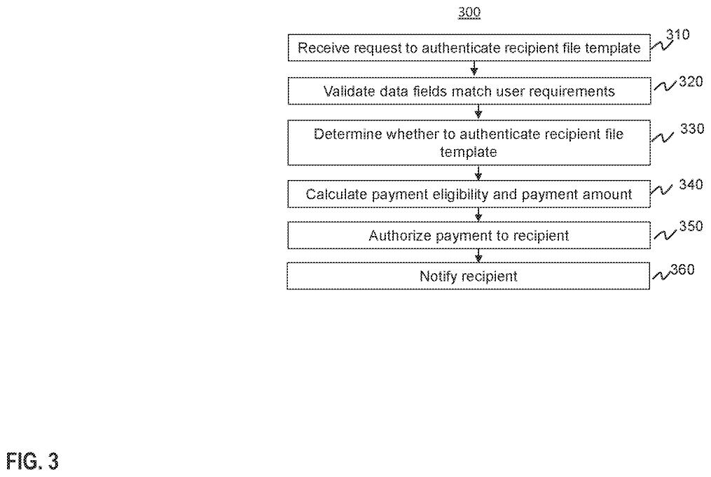

FIG. 3 is a flowchart showing an example process for automatic payment distribution, consistent with disclosed embodiments. Process 300 may be performed by at least one processing device of a server, such as processor 220, as described above. In some embodiments, a non-transitory computer readable medium may contain instructions that when executed by a processor cause the processor to perform process 300. Further, process 300 is not necessarily limited to the steps shown in FIG. 3, and any steps or processes of the various embodiments described throughout the present disclosure may also be included in process 800, including those described above with respect to, for example, FIGS. 1A, 1B, and 1C.

In step 310, process 300 may include receiving a request to authenticate a recipient file template, wherein the recipient file template contains data fields for a recipient. In some embodiments, the recipient file template may be of file formats such as Excel, flat file, database, CSV, YAML, and XML. In some embodiments, the data fields are specific to employing entities 106. In some embodiments, recipients are people eligible for a payment distribution. In some embodiments, the recipient is selected from a database of eligible recipients. In some embodiments, employing entities 106 determines which recipients are eligible based on employing entities 106 specified rules.

In step 320, process 300 may include validating, based on user-specified rules, that the data fields match user requirements. In some embodiments, the data fields include personal identifiable information. In some embodiments, personal identifiable information is information that permits the identity of an individual to be reasonably inferred by either direct or indirect means. Personal identifiable information may directly identify an individual, such as a name, address, social security number, telephone number, or email address. Personal identifiable information may also include information that employing entities 106 use to identify specific payment recipients 162. In some embodiments, matching requires confirming that all appropriate data fields have been filled out. In some embodiments, matching may require confirming that all data fields match information for a specific payment recipient 162. In some embodiments, the user-specified rules are configuration based. In some embodiments, the configuration-based rules are preconfigured or predefined. In other embodiments, the configuration-based rules are customizable to specify under which conditions a particular setting is applied. In some embodiments, the payment amount is limited based on user-specified rules. In some embodiments, employing entities 106 may determine the user-specified rules. Employing entities 106 may customize the rules based on information needed to validate and authorize a payment to a payment recipient. In some embodiments, an administrator has full permissions within the user-specified rules. In some embodiments, an administrator may have permission to change a payment recipient 162's address. In other embodiments, an administrator may have permission to re-issue a payment. In other embodiments, an administrator may flag a payment for review.

In step 330, process 300 may include determining whether to authenticate the recipient file template based on the validation. Authentication methods may include password-based authentication, multi-factor authentication, or certificate-based authentication. In some embodiments, password-based authentication is the process of gaining access to system 100 using a set of credentials containing a username and password. In some embodiments, multi-factor authentication is an electronic authentication method that grants authorization after two or more credentials are verified. In some embodiments, certificate-based authorization uses a digital certificate for identification before granting access to system 100.

In step 340, process 300 may include calculating, based on the data fields, at least one of payment eligibility and payment amount. In some embodiments, payment eligibility may require determining if a specific payment recipient is still eligible to receive a payment based on information received at step 310 in the recipient file template. Eligibility criteria may be specific to an employing entity 106. For example, eligibility criteria may include gross monthly income or net income that falls below a certain limit, assets that fall below a certain limit, a certain number of dependents, employment status of a payment recipient, including whether or not a payment recipient is a college student, immigration status of a payment recipient, disability status of a payment recipient, certain medical conditions including pregnancy of a payment recipient, payment recipient's age, and payment recipient's jurisdictional residency. In some embodiments, each employing entity 106 may have its own eligibility criteria. In some embodiments, if at step 340, process 300 determines that a payment recipient is not eligible, then process 300 does not continue. In some embodiments, calculating the payment amount may require determining the exact payment amount a payment recipient is entitled to.

In step 350, process 300 may include authorizing an automatic payment to a recipient. In some embodiments, when a payment is authorized, process 300 logs the payment as a transaction. In some embodiments the payment transaction is an encrypted transaction. In some embodiments, data elements marked as personal identifiable information are encrypted. In other embodiments, all data elements are encrypted. In some embodiments, step 350 may only occur if both payment eligibility and payment amount are calculated at step 340. In other embodiments, step 350 may occur if one of payment eligibility and payment amount are calculated at step 340. In some embodiments, the automatic payment may further comprise a payment method of at least one of a check, Automated Clearing House (ACH) payment, or debit to a bank account. In some embodiments, each payment method is logged in a positive pay file. In some embodiments, a positive pay file is a list of each payment that an employing entity has written during a defined period of time, which can be transmitted to a financial institution to use the list to verify that the payments are valid. In some embodiments, the positive pay file is used specifically to determine that a check is valid for cashing by comparing the check number and dollar amount of the check against the cashed check. The positive pay file helps protect employing entities against fraudulent behavior for forged, altered, or counterfeit checks. In some embodiments, a notification is generated if a payment is attempted more than once. In some embodiments, generating this notification helps to prevent fraudulent payments. In some embodiments, process 300 prevents a payment from occurring more than once.

In some embodiments, at step 350, authorizing a payment may require validating a payment recipient address. In other embodiments, authorizing a payment may require confirming financial information with a financial institution.

In step 360, process 300 may include notifying the recipient of a status of the payment. In some embodiments, the payment recipient 162 may receive a notification via an email, text message, phone call, or system alert, based on the user-specified rules. In some embodiments, the payment recipient 162 may receive a notification that the payment was authorized and went through. In other embodiments, the payment recipient 162 may receive a notification that the payment was not authorized and no payment was made.

In some embodiments, the steps of process 300 may only be within a system by a user with specific permissions. In some embodiments, process 300 may determine a user's authorization or status. In other embodiments, an administrator with certain permissions may determine a user's authorization or status. In some embodiments, a user may be a read-only user. In other embodiments, a user may be an upload-only user. In some embodiments, a user may be a call center agent or an administrator. In some embodiments, a call center agent may perform operations that include searching for a payment recipient 162 in database 102, reporting a payment recipient 162, searching database 102 for other data field information, reviewing payment history for a payment recipient 162 or viewing payment status for a payment recipient 162. Payment status may include information on whether or not a payment was made.

FIG. 4 illustrates an example of a search screen 410 where users can search for different upload recipients. In some embodiments, search screen 410 may be hosted by, prepared by, displayed by, or otherwise generated by search and retrieval services 134, for presentation to a user using one or more of devices hosted on system 300. In some embodiments, employing entities 106 performs a search using search and retrieval services 134. In other embodiments, agency administrators 108 performs a search using search and retrieval services. In other embodiments, call center agents 110 performs a search using search and retrieval 134. In some embodiments, a device may be a personal computer (e.g., a desktop or laptop computer), a mobile device (e.g., a mobile phone or tablet), a wearable device (e.g., a smart watch, smart jewelry, implantable device, fitness tracker, smart clothing, head-mounted display, etc.), an IoT device (e.g., smart home devices, industrial devices, etc.), or any other device that may be capable of accessing web pages or other network locations. In some embodiments, a user may view and interact with search screen 410 by viewing search screen 410 over a network such as the Internet

In some embodiments, a user can search database 102 through any field set up by employing entities 106. In other embodiments, a user can search for an upload recipient based on user-specified rules. For example, as shown in FIG. 4, a user can conduct a keyword search at search box 420. In some embodiments, a user can search by recipient name at recipient name search box 430. In some embodiments, a user can search by a recipient's address at address search box 440. In some embodiments, a recipient can search by payment status at payment status search box 450. Examples of payment status include authorized, denied, or pending. In other embodiments, the user-specified rules may include additional search criteria, as shown in additional information search box 460. In other embodiments, a user may add additional search information, as shown in additional search information box 470. As depicted in additional search information box 470, a user may select the plus button to customize fields to search for an upload recipient. In some embodiments, a call center agent may perform at least one of It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. An automatic payment distribution system, comprising:
a database,
a memory storing instructions; and
at least one processor configured to execute the instructions to:
receive, from a user device, a request to authenticate a recipient file template, wherein the recipient file template contains data fields for a recipient;
validate, based on user-specified rules, that the data fields match user requirements;
determine whether to authenticate the recipient file template based on the validation;
calculate, based on the data fields, at least one of payment eligibility and payment amount;
authorize an automatic payment to a recipient; and
send the payment to a payment disbursement system.

2. The system of claim 1, wherein the operations further comprise logging each authorized payment to a recipient as a transaction.

3. The system of claim 1, wherein the payment to a recipient further comprises a payment method of at least one of a check, ACH payment, or debit to a bank account.

4. The system of claim 3, the operations further comprising:
logging each payment method in a positive pay file; and
generating a notification if a payment is attempted more than once.

5. The system of claim 1, wherein the recipient is selected from a database of eligible recipients.

6. The system of claim 1, wherein the operations further comprise:
denying authorization of payment to a recipient; and
logging the denied authorization of payment to a recipient.

7. The system of claim 1, wherein the user-specified rules are configuration-based.

8. The system of claim 1, wherein the operations further comprise sending a notification of at least one of an email, text message, phone call, or system alert, based on the user-specified rules when a payment is sent to a payment disbursement system.

9. The system of claim 1, wherein each payment is an encrypted transaction.

10. A non-transitory computer readable medium including instructions that, when executed by at least one processor, cause the at least one processor to perform operations for automatic payment distribution, comprising:
receive, from a user device, a request to authenticate a recipient file template, wherein the recipient file template contains data fields for a recipient;
validate, based on user-specified rules, that the data fields match user requirements;
determine whether to authenticate the recipient file template based on the validation;
calculate, based on the data fields, at least one of payment eligibility and payment amount;
authorize a payment to a recipient; and
notify the recipient of a status of the payment.

11. The non-transitory computer-readable medium of claim 10, wherein the operations further comprise determining a user's authorization or status, wherein the user includes at least one of a read-only user, an upload-only user, a call center agent, or an administrator;

12. The non-transitory computer-readable medium of claim 11, wherein the administrator has full permissions within the user-specified rules including changing the payment recipient's address, re-issuing check payments, or flagging payments for review.

13. The non-transitory computer-readable medium of claim 11, wherein the operations further comprise the call center agent performing at least one of:
searching for a payment recipient;
reporting a payment recipient;
searching a database;
reviewing payment history; or
viewing payment status.

14. The non-transitory computer-readable medium of claim 10, wherein the data fields include personal identifiable information.

15. The non-transitory computer-readable medium of claim 10, wherein authorizing a payment further comprises:
validating the payment recipient's address; and
confirming financial information with a financial institution.

16. The non-transitory computer-readable medium of claim 10, wherein the operations further comprise the payment recipient receiving multiple payments.

17. The non-transitory computer-readable medium of claim 10, wherein the payment amount has a limit based on user-specified rules.

18. A computer-implemented method for automatic payment distribution, comprising:
receiving, from a user device, a request to authenticate a recipient file template, wherein the recipient file template contains data fields for a recipient;
validating, based on user-specified rules, that the data fields match user requirements;
determining whether to authenticate the recipient file template based on the validation;
calculating, based on the data fields, at least one of payment eligibility and payment amount;
authorizing a payment to a recipient; and
notifying the recipient of a status of the payment.

19. The computer-implemented method of claim 18, wherein the user-specified rules are determined by an employing entity.

20. The computer-implemented method of claim 18, wherein the operations further comprise an administrator changing the user requirements.
